(19) United States
(12) Patent Application Publication
(10) Pub. No.: US 2021/0064652 A1
(43) Pub. Date: Mar. 4, 2021

(54) CAMERA INPUT AS AN AUTOMATED FILTER MECHANISM FOR VIDEO SEARCH

(71) Applicant: Google LLC, Mountain View, CA (US)

(72) Inventors: Diane Wang, San Francisco, CA (US); Austin McCasland, San Francisco, CA (US); Paulo Coelho, Milpitas, CA (US)

(21) Appl. No.: 16/948,119

(22) Filed: Sep. 3, 2020

Related U.S. Application Data
(60) Provisional application No. 62/895,278, filed on Sep. 3, 2019.

(51) Int. Cl. G06F 16/535; G06F 16/583; G06N 20/00; G06F 16/58; G06F 16/55

(52) U.S. Cl. CPC G06F 16/535; G06F 16/5846; G06F 16/55; G06F 16/5866; G06N 20/00

(57) ABSTRACT

A method including receiving at a first time a textual query, receiving at a second time after the first time a visual input associated with the textual query, generating text based the visual input, generating a composite query based on a combination of the textual query and the text based on the visual input, and generating search results based on the composite query, the search results including a plurality of links to content.

### CROSS REFERENCE TO RELATED APPLICATION

This application claims the benefit of U.S. application Ser. No. 62/895,278, filed Sep. 3, 2019, the disclosure of which is incorporated herein by reference in its entirety.

### FIELD

Example implementations relate to searching for content and storing searchable content using a user interface.

### BACKGROUND

Searching for content (e.g., articles, information, instructions, video and/or the like) usually involves entering text (e.g., a search string) into a textbox and initiating (e.g., by a keystroke or clicking a button) a search of a data structure (e.g., a database, a knowledge graph, a file structure, and/or the like) using a user interface (e.g., of a browser, an application, a website, and/or the like). The search can be text based and the search response or results can be a set of links to content determined to be related to the text or search string. The results can be displayed on the user interface.

### SUMMARY

In a general aspect, a device, a system, a non-transitory computer-readable medium (having stored thereon computer executable program code which can be executed on a computer system), and/or a method can perform a process with a method including receiving at a first time a textual query, receiving at a second time after the first time a visual input associated with the textual query, generating text based the visual input, generating a composite query based on a combination of the textual query and the text based on the visual input, and generating search results based on the composite query, the search results including a plurality of links to content.

In another general aspect, a device, a system, a non-transitory computer-readable medium (having stored thereon computer executable program code which can be executed on a computer system), and/or a method can perform a process with a method including receiving a textual query, receiving a visual input associated with the query, generating search results based on the textual query, generating textual metadata based on the visual input, filtering the search results using the textual metadata, and generating filtered search results based on the filtering, the filtered search results providing a plurality of links to content.

In yet another general aspect, a device, a system, a non-transitory computer-readable medium (having stored thereon computer executable program code which can be executed on a computer system), and/or a method can perform a process with a method including receiving a content, receiving a visual input that is associated with the content, performing an object identification on the visual input, generating semantic information based on the object identification, and storing the content and the semantic information in association with the content.

Implementations can include one or more of the following features. For example, the composite query can be a first composite query. The creating of the first composite query can include performing an object identification on the visual input, and performing a semantic query addition on the query using at least an object identified based on the object identification to generate the first composite query, wherein the search results are based on the first composite query. The performing of the object identification can use a trained machine learned model. The performing of the object identification can use a trained machine learned model, the trained machine learned model can generate classifiers for objects in the visual input, and the performing of the semantic query addition can include generating the text based on the visual input based on the classifiers for the objects.

The method can further include determining if a first confidence level in the object identification satisfies a first condition, and the performing the semantic query addition on the query using at least the object identified that satisfies the first condition to generate a second composite query, the search results can be based on the second composite query. The method can further include determining if a second confidence level in the object identification satisfies a second condition, and performing the semantic query addition on the query using at least the object identified that satisfies the second condition to generate a third composite query, wherein the search results are based on the third composite query. The second confidence level can be higher than the first confidence level. The first condition and second condition can be configured by a user.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a block diagram of a user interface apparatus according to at least one example embodiment.

FIG. 1B illustrates a block diagram of a user interface apparatus according to at least one example embodiment.

FIG. 2A illustrates a block diagram of an apparatus according to at least one example embodiment.

FIG. 2B illustrates a block diagram of a memory according to at least one example embodiment.

FIG. 3 illustrates an example use case for an automated filter mechanism for video search, according to at least one example implementation.

FIG. 4 illustrates a block diagram of a method for building a search query with visual input, according to at least one example implementation.

FIG. 5 illustrates a block diagram of a signal flow for visual matching using indexed video content, according to at least one example implementation.

FIG. 6 illustrates a flowchart of a method for building a search query with visual input, according to at least one example implementation.

FIG. 7 illustrates a flowchart of a method of visual matching using indexed video content, according to at least one example implementation.

FIG. 8 illustrates a flowchart of a method of visual matching of video content, according to at least one example implementation.

FIG. 9A illustrates layers in a convolutional neural network with no sparsity constraints.

FIG. 9B illustrates layers in a convolutional neural network with sparsity constraints.

FIG. 10 illustrates a block diagram of a model according to an example embodiment.

FIG. 11 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION

A user may be interested in finding, for example, videos with a specific content. However, text-based searches may not produce the most relevant search results (e.g., links to content) and/or may produce an excessive number of search results that may or may not be relevant. For example, the search is limited by the text and the user may not know the key words to search with.

Example implementations describe mechanisms including using an input image to generate (or help produce) text that can be used as search text. For example, the image can be used to generate the text used in the search and/or text to be concatenated to previously entered text. Further, an input image can be used when uploading content. The input image can be used to generate text that can be stored as key words associated with the content and used to produce (or help produce) results in a future search for content.

Example implementations are more efficient and/or useful because an image can be used to generate search text that can be more complete with regard to the content the user is interested in. As a result, the amount of time the user may be required to sort through can be significantly reduced because the user should not have to filter through hundreds/thousands of search results (e.g., links to content) looking for the relevant content (e.g., product reviews, videos, price comparisons, use instructions, and/or the like).

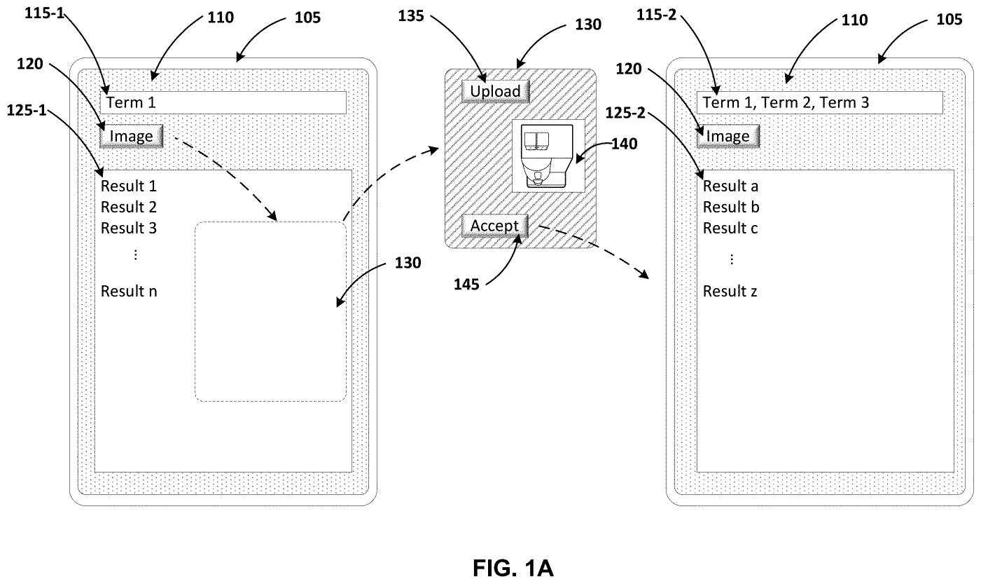

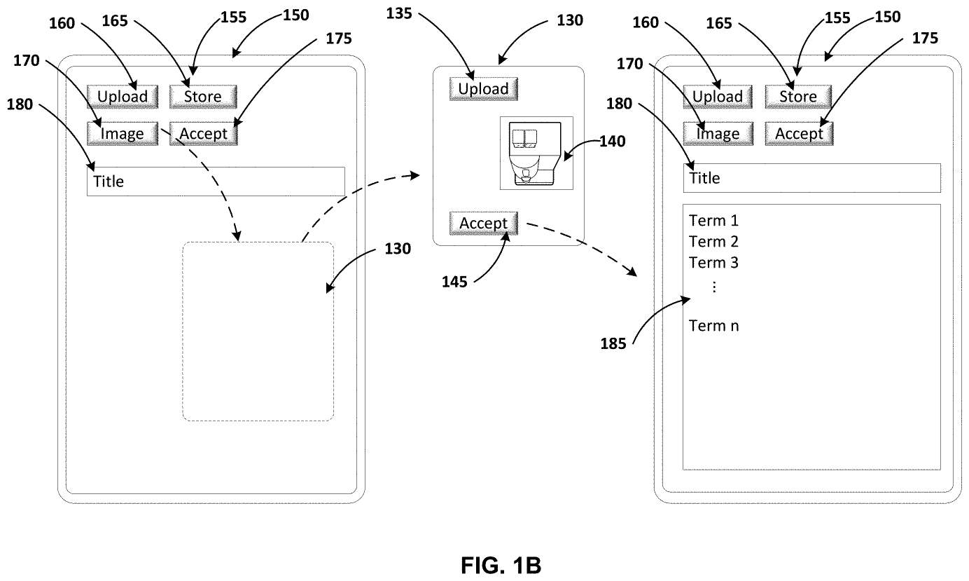

FIG. 1A illustrates a block diagram of a user interface apparatus according to at least one example embodiment. As shown in FIG. 1A, a device 105 can include a user interface (UI) 110. The UI 110 can include a textbox 115, a button 120, and a textbox 125. In an example implementation, the textbox 115 can be configured to allow text entry and use the text in a search or search text. The textbox 125 can be configured to display the search results. In the example of FIG. 1A, initially the textbox 115-1 includes the text Term 1 as the search text. After the search is complete, the textbox 125-1 include the search results including Result 1, Result 2, Result 3, . . . , and Result n. In addition, the UI 110 can be configured to generate environmental information query text (e.g. location, prior search history and preferences) without the user explicitly entering the query text. The environmental information query text can be concatenated to the search text (e.g., the textual query, query string, and/or the like).

The user of UI 110 can operate on (e.g., click, push, depress, and/or the like) button 120. In response to operating on button 120, UI 130 can become visible (e.g., open, pop-up, and/or the like) on device 105 (shown as a dotted rectangle on device 105). UI 130 includes a button 135, an image display portion 140, and a button 145. Button 135 can be configured to trigger the selection of an image (e.g., capture via a camera interface, select as a stored, and/or the like). In response to selecting the image, the image can be displayed (e.g., as a thumbnail image) in the image display portion 140. Displaying the image in the image display portion 140 can give the user of the UI the opportunity to confirm the image is as desired and/or intended. Button 145 can be configured to trigger the generation of search terms based on the selected image (e.g., as displayed in the image display portion 140) and close the UI 130 (e.g., no longer display).

In response to completing actions with UI 130, the textbox 115-2 includes the text Term 1 as well as Term 2 and Term 3 as the search text. Term 2 and Term 3 can be the search terms or semantic information generated based on the selected image. The additional search terms or semantic information can be more precise because the search terms are related to the image which should be of an item of interest (e.g., a coffee pot, a flower, an automobile, a book, an automobile, and/or the like). In response to triggering a new search, the textbox 125-2 include the search results including Result a, Result b, Result c, . . . , and Result z.

In an example use case, a user may enter fix coffee pot as a textual query (e.g., text to use in a search) in textbox 115 and trigger a search for content. A result list may be returned and displayed in textbox 125. The result list can include content related to fixing a coffee pot for many makes and models of coffee pots. The user can scan through the result list for a particular make and model, or the user can click on button 120 causing UI 130 to be displayed. The user can take a picture of the broken coffee pot which will be displayed in the image display portion 140 and click on the button 145. Clicking on the button 145 can trigger an analysis of the image and generate semantic information (e.g., text) based on the image. The semantic information can be the make and model of the coffee maker which is concatenated onto the textual query as, for example, fix coffee pot, make, model. A new result list is then generated using the concatenated textual query (e.g., a semantic query). The new result list can be based on a new search or a filter of the original search. Therefore, the new result list may have content (e.g., a video) on the top of the result list (e.g., ranked high) describing or showing how to fix a make, model coffee maker. Alternatively, the result list may not include content that does not include the make and model of the coffee maker. The new result list is displayed in textbox 125. The new result list can be more precise because of the use of the semantic information resulting in a minimal scan of the result list by the user for the desired content.

According to example implementations, the new result list should be more precise than the original search because of the additional (e.g., concatenated with the original) search terms. The new result list may limit or reduce the amount of time the user may be required to sort through to find the desired content as compared to the original result list. The new result list may be ranked based on the additional search terms. The ranking may result in content including the additional search terms having a higher ranking. Therefore, new result list may include content including the additional search terms at the top (e.g., first, second, the beginning, and/or the like) of the new result list.

FIG. 1B illustrates a block diagram of a user interface apparatus according to at least one example embodiment. As shown in FIG. 1B, a device 150 includes a user interface (UI) 155. The UI 155 includes a button 160, a button 165, a button 170, a button 175, and a textbox 180. In an example implementation, a user of UI 155 can operate on (e.g., click, push, depress, and/or the like) button 160. In response to operating on button 160, a file select window can open and the user can select content (e.g., a video, instructions, an article, and/or the like). The user can then enter a name for the content in textbox 180. The name can be a portion of the keywords that will cause a link to the content to be included in a search result list. For example, the keywords may be fix and coffeemaker (which can describe the content of a video).

The user of UI 155 can operate on (e.g., click, push, depress, and/or the like) button 170. In response to operating on button 170, UI 130 can become visible (e.g., open, pop-up, and/or the like) on device 150 (shown as a dotted rectangle on device 150). UI 130 includes a button 135, an image display portion 140, and a button 145. Button 135 can be configured to trigger the selection of an image (e.g., capture via a camera interface, select as a stored, and/or the like). In response to selecting the image, the image can be displayed (e.g., as a thumbnail image) in the image display portion 140. Displaying the image in the image display portion 140 can give the user of the UI the opportunity to confirm the image is as desired and/or intended. Button 145 can be configured to trigger the generation of search terms based on the selected image (e.g., as displayed in the image display portion 140) and close the UI 130 (e.g., no longer display).

In response to completing actions with UI 130, the textbox 185 includes the text Term 1, Term 2, Term 3, . . . , and Term n as terms that describe the image. Therefore, the terms that describe the image can be additional keywords or semantic information that will cause a link to the content to be included in a search result list. For example, in addition to the keywords fix and coffeemaker, keywords brand, model, serial number, and the like can be additional keywords that are based on the image. In an example implementation, the new terms (e.g., semantic query text) can be used as feedback to the tool (e.g., a machine learned (ML) model) to improve the tool (e.g., train the ML model. For example, if the user adds text, a feedback can be triggered such that a future generation of text based on a similar image (e.g., of the same coffee maker) may include the additional text.

The button 165 can be configured to cause the content and the keywords or semantic information to be stored (e.g., as metadata) to a searchable data structure (e.g., a database, a knowledge graph, a file structure, and/or the like) while leaving UI 155 open on device 150 (e.g., to allow uploading additional content. The button 175 can be configured to cause the content and the keywords to be stored (e.g., as metadata) to a searchable data structure (e.g., a database, a knowledge graph, a file structure, and/or the like) while closing UI 155 (e.g., no longer viewable on device 150). The content stored using UI 155 can be searched using UI 110. Using this technique, an image of the same item (e.g., a coffee maker) can cause the same terms to be used in the upload/storing of content (e.g., a video of fixing the coffee maker) as in the searching for the content.

The UI 130 can include associated functionality that can recognize objects and portions of objects in the image and generate terms or semantic information associated with the objects. In addition, the UI 130 can include and/or be associated with memory that can include storing code to implement the functionality, data structures for storing images, terms, and/or the like, and a searchable data structure (e.g., a database, a knowledge graph, a file structure, and/or the like). The UI 130 can be implemented as code stored in a memory and executed by a processor.

In an example use case, a user may upload (e.g., using button 160) content (e.g., a video) about how to fix a coffee pot. The user can click on button 120 causing UI 130 to be displayed. The user can take a picture of the coffee pot (e.g., possibly a broken coffee pot) which will be displayed in the image display portion 140 and click on the button 145. Clicking on the button 145 can trigger an analysis of the image and generate semantic information (e.g., text) based on the image. The semantic information can be the make and model of the coffee maker. The uploaded content can be stored in association with the semantic information (e.g., as metadata or textual metadata). Therefore, the content about how to fix a coffee pot can be stored in association with the make and model of the coffee pot. A future search for the uploaded content, how to fix a coffee pot, that includes a textual query including semantic information, make and model, that is generated using a similar technique to the semantic information associated with the uploaded content should result in a link to the uploaded content being in a result list. This can result in a more precise result list when content is uploaded and stored using semantic information based on the image and content searched for using semantic information based on the image.

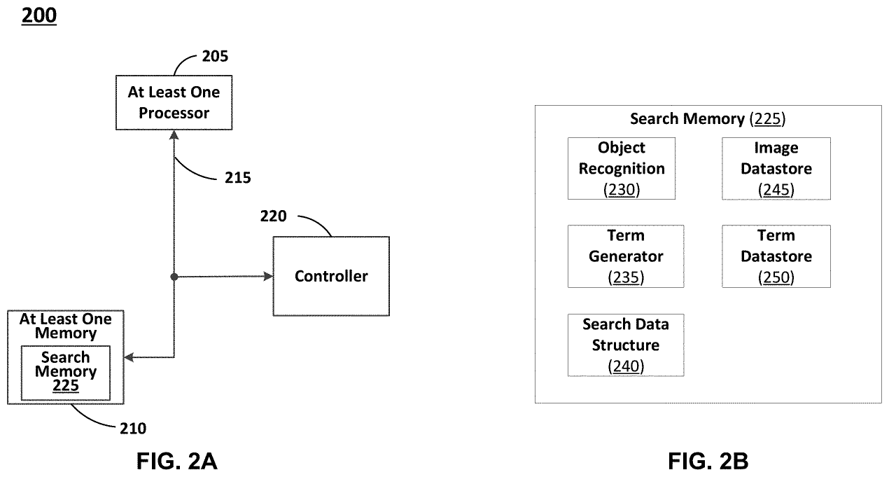

FIG. 2A illustrates a block diagram of portion of an apparatus including a search mechanism according to at least one example embodiment. As shown in FIG. 2A, the apparatus 200 includes at least one processor 205, at least one memory 210, and a controller 220. The at least one memory includes a search memory 225. The at least one processor 205, the at least one memory 210, and the controller 220 are communicatively coupled via bus 215.

In the example of FIG. 2A, the apparatus 200 may be at least one computing device and should be understood to represent virtually any computing device configured to perform the techniques described herein. As such, the apparatus 200 may be understood to include various components which may be utilized to implement the techniques described herein, or different or future versions thereof. For example, the apparatus 200 is illustrated as including at least one processor 205, as well as at least one memory 210 (e.g., a computer readable storage medium).

Therefore, the at least one processor 205 may be utilized to execute instructions stored on the at least one memory 210. As such, the at least one processor 205 can implement the various features and functions described herein, or additional or alternative features and functions (e.g., a search mechanism or tool). The at least one processor 205 and the at least one memory 210 may be utilized for various other purposes. For example, the at least one memory 210 may be understood to represent an example of various types of memory and related hardware and software which can be used to implement any one of the modules described herein. According to example implementations, the apparatus 200 may be included in larger system (e.g., a server, a personal computer, a laptop computer, a mobile device and/or the like).

The at least one memory 210 may be configured to store data and/or information associated with the search memory 225 and/or the apparatus 200. The at least one memory 210 may be a shared resource. For example, the apparatus 200 may be an element of a larger system (e.g., a server, a personal computer, a mobile device, and the like). Therefore, the at least one memory 210 may be configured to store data and/or information associated with other elements (e.g., web browsing or wireless communication) within the larger system (e.g., an audio encoder with quantization parameter revision).

The controller 220 may be configured to generate various control signals and communicate the control signals to various blocks in the apparatus 200. The controller 220 may be configured to generate the control signals in order to implement searching using object recognition based on an image technique or other techniques described herein.

The at least one processor 205 may be configured to execute computer instructions associated with the search memory 225, and/or the controller 220. The at least one processor 205 may be a shared resource. For example, the apparatus 200 may be an element of a larger system (e.g., a server, a personal computer, a mobile device, and the like). Therefore, the at least one processor 205 may be configured to execute computer instructions associated with other elements (e.g., serving web pages, web browsing or wireless communication) within the larger system.

FIG. 2B illustrates a block diagram of a memory according to at least one example embodiment. As shown in FIG. 2B, the search memory 225 can include an object recognition 230 block, a term generator 235 block, a search data structure 240 block, an image data store 245 block, and a term datastore 250 block.

The object recognition 230 block can be configured to identify any objects included in the image uploaded using UI 130. The objects can include the primary object in the image (e.g., a coffee maker) and any portions of the primary object (e.g., identifying text, components, and/or the like). Identifying objects can include the use of a trained machine learned (ML) model. The trained ML model can be configured to generate classifiers and/or semantic information or text associated with the object. The ML model can include a function call to a server including code to execute the model. The ML model can include a function call within code of the UI (e.g., UI 130) which can include code (e.g., as an element of the object recognition 230 block) to execute the model. An example of an ML model for object recognition is described in more detail below.

The term generator 235 block can be configured to generate terms and/or semantic information based on the objects identified by the object recognition 230 block. For example, the object recognition 230 block can classify each object. The classification can have a corresponding term and/or semantic information. The classification can have additional information to further generate the term and/or semantic information. For example, a classification of model number can also include the model number as information determined from the image. The classification can be more inclusive. For example, the classification can be text and the additional information can be the model number. The term generator 235 can be configured to use the additional information without the classification. For example, the determined model number can be the term without using text or model number (e.g., the classification).

The search data structure 240 block can be configured to store a search data structure, metadata, and/or a link to a search data structure. The search data structure 240 can be, for example, a database, a knowledge graph, a file structure, and/or the like. The search data structure 240 can be configured to receive a search string and return a result list based on the search string.

The image data store 245 block can be configured to store images and/or metadata associated with the image as input via UI 130. The term datastore 250 block can be configured to store terms and/or metadata as generated by the term generator 235. The terms can be stored in relation to an object classification.

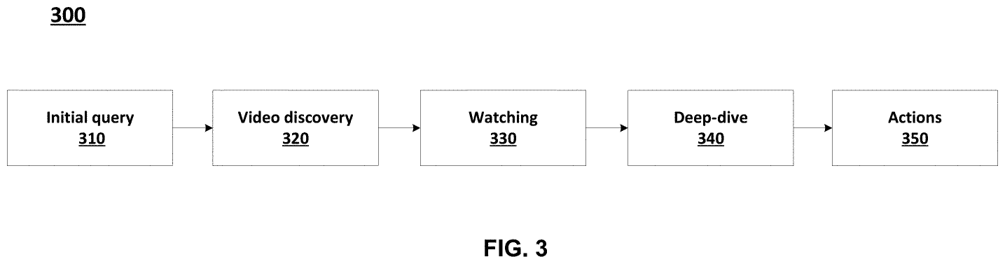

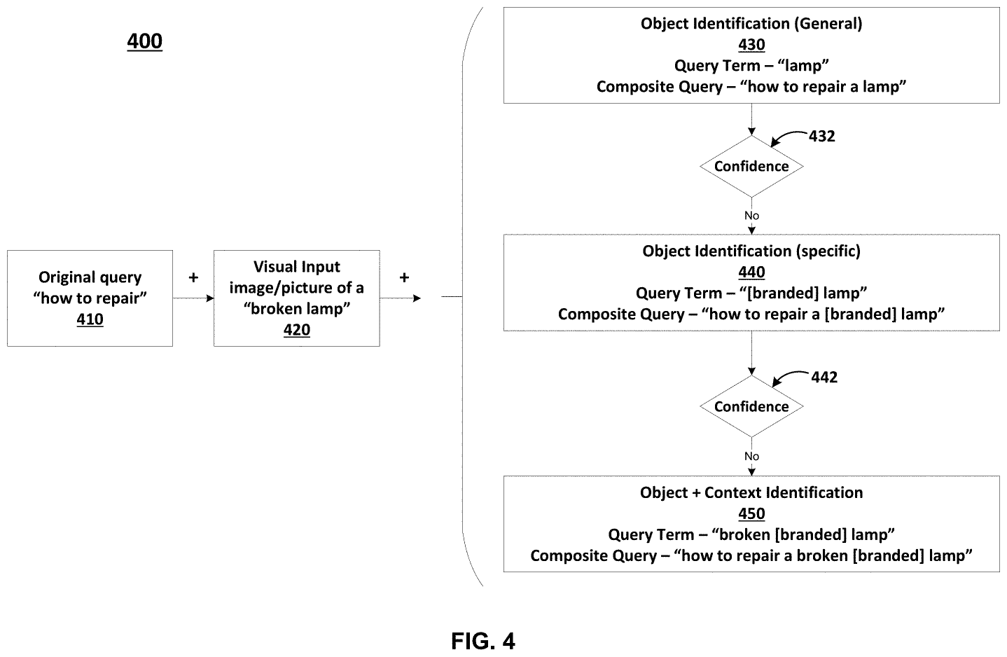

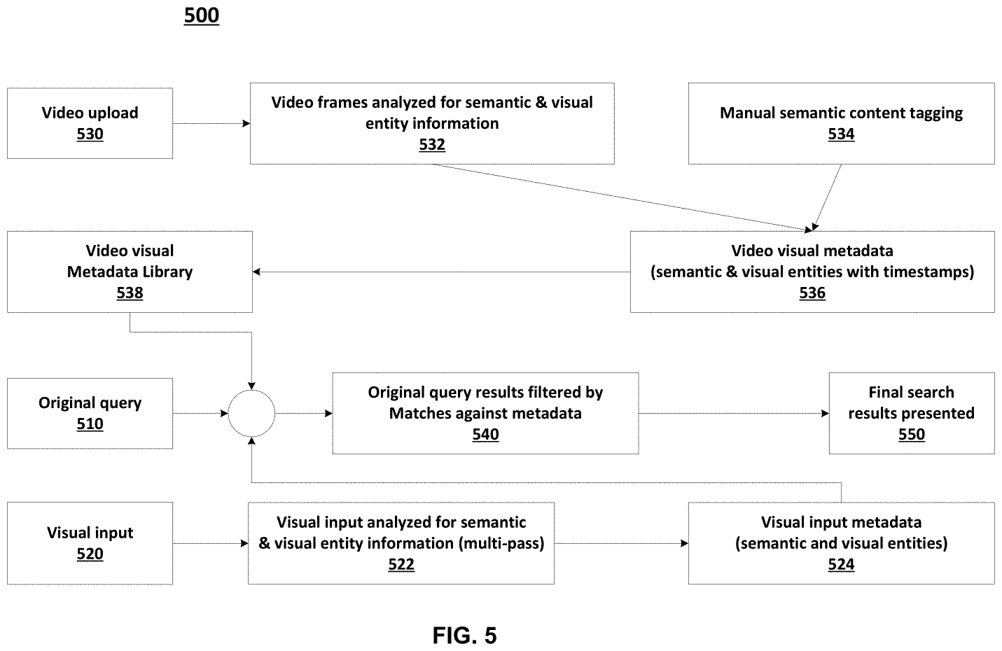

FIG. 3 illustrates an example use case of an automated filter mechanism 300 for video search, according to at least one example implementation. At block 310, a computing device (e.g., laptop computer, a desktop computer, a mobile device, and/or the like) may receive an initial query (e.g., a search query/string). The initial query can include text entered using a user interface (e.g., UI 110). The initial query can include additional text based on an image (e.g., using UI 130). The initial query can include searching a search data structure for video content based on the text. The initial query can return search results or a result list including links to at least one content (e.g., video). In some implementations, the initial query may be an “original query” (e.g., block 410 of FIG. 4 and block 510 of FIG. 5) and/or the home feed may be a “visual input” (e.g., block 420 of FIG. 4 and block 520 of FIG. 5) as described below in reference to FIGS. 4-7.

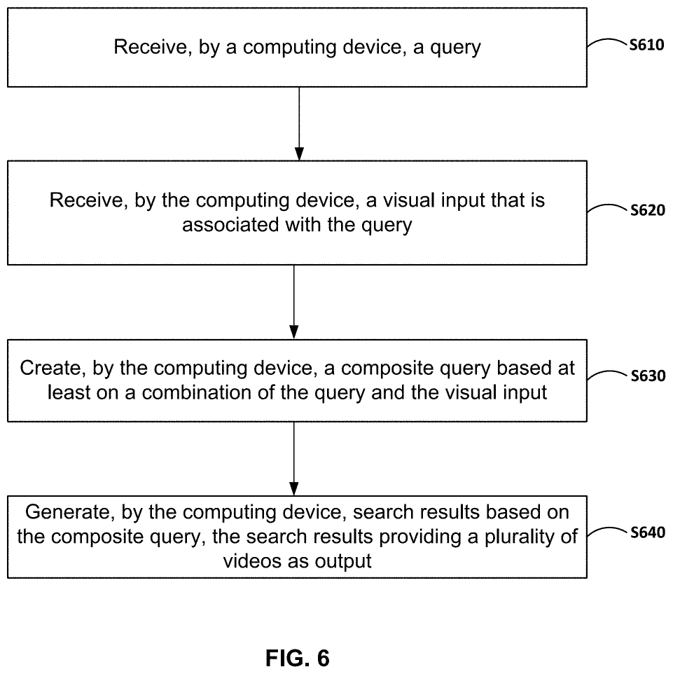

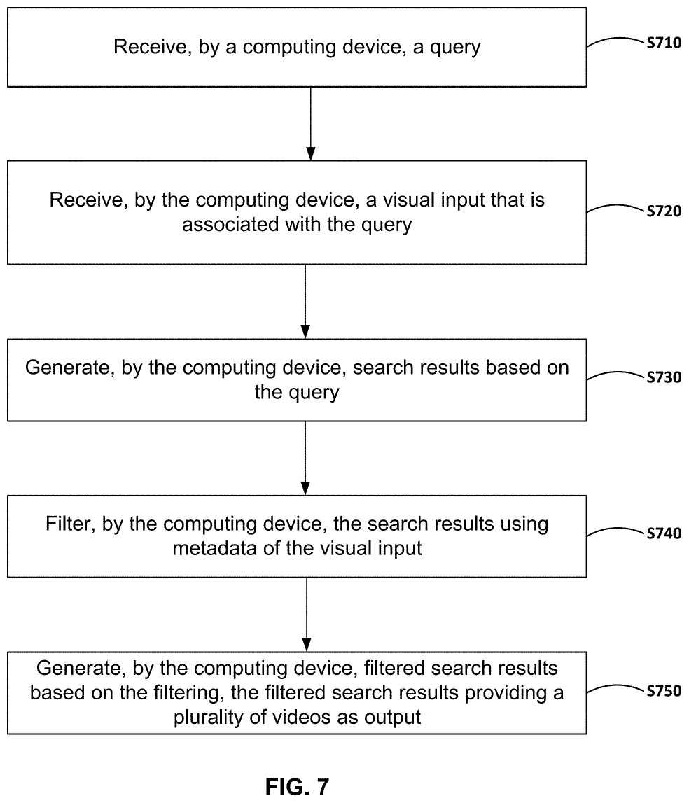

At block 320, the computing device may output videos (e.g., video discovery) based on the search performed at 310. The user of a user interface (e.g., UI 110) can select content (e.g., a video) using the links of the search results. The content (e.g., video) can be displayed on the computing device (e.g., device 105). In some implementations, the search results may be based on a search performed using a search query with visual input as described below in reference to FIGS. 4 and 6 or visual matching using indexed content as described in detail below in reference to FIGS. 5 and 7. The links to videos selectable at block 320 can be relevant videos that are filtered based not only the query text but also based on the visual input (e.g., an image) provided by the user (e.g., via UI 130) as described above.

At block 330, the user may watch/view the content (e.g., video) and, at block 340, perform a deep-dive (e.g., further interactions) into the content. For example, in some implementations, the user may view the video and may perform a deep-dive into the video. The deep-dive can also be reading product instructions (e.g., assembly or care instructions), environment examples (e.g., planting or caring for flowers), and/or the like.

At block 350, the user may perform an action(s) based on the content (e.g., the deep-dive of the video). In some implementations, the actions performed by the user may include online shopping, fixing a broken appliance, planting a flower, and/or the like.

FIG. 4 illustrates a block diagram 400 of a method for building a search query with visual input, according to at least one example implementation. In an example implementation, a user may be searching for content. For example, the user may be searching videos on how to fix a broken lamp.

At block 410, the user may enter a query in a search engine. For example, the user may enter text in a user interface (e.g., UI 110) configured to implement (or help implement) a search for content using a search engine. In some implementations, the query (e.g., referred to as original query in FIG. 4) may be a “how to” search string (e.g., “how to repair”). The search engine may be associated with a video repository or application. Therefore, the query may be searching for a video (e.g., a “how to repair” video).

At block 420, the user may be prompted to upload an image or a picture. The image uploaded by the user may be referred to as “visual input” from the user. In some implementations, for example, the visual input may be triggered in response to the user entering the search string, in response to some user interaction in a user interface, in response to the user clicking on a button, and/or the like. In some implementations, the user may be prompted to upload the image before entering the query. In other words, block 420 may be performed before block 410.

At block 430, a composite query may be created based on a combination of the query and text based on the visual input. In some implementations, for example, the composite query may be created based on semantic query addition. In some implementations, the text based on the visual input can be generated in response to object recognition of objects in the visual input. For example, a trained ML model can be used recognize objects in the visual input. The recognized objects can be classified and terms (e.g., text) can correspond to the classification. The trained ML model can be configured to generate classifiers and/or semantic information or text associated with the object. The trained ML model can be configurate a confidence or confidence level based on how likely the object recognition and/or classification is accurate.

In one example implementation, at block 430, the composite query may be based on general object identification to generate the composite query “how to repair a lamp.” In the general object identification, for example, specific product or classification of an object may not be available.

In an additional example implementation, at block 440, the composite query may be based on specific object identification to generate the composite query “how to repair a [branded] lamp.” The specific object identification may be used if the confidence level, at 432, in the objection identification satisfies a certain condition (a first condition) which may be, for example, above or below a first threshold. In the specific object identification, for example, specific product or classification of an object may be identified.

In another additional example implementation, at block 450, the composite query may be based on object and context identification to generate the composite query “how to repair a broken [branded] lamp.” The object and context identification may be used if the confidence level, at 442, in the object and context identification satisfies a certain condition (a second condition) which may be, for example, above or below a second threshold. In the “object+context” identification, for example, specific/general identification along with an understanding of the user's intent may not be available.

Therefore, more relevant search results may be generated based on composite queries beginning with general object identification and moving to full contextual identification (e.g., of the visual input). The more complete or accurate the contextual identification of the visual input, the less the amount of time the user may be required to sort through search results (e.g., links to content) looking for the relevant content (e.g., product reviews, videos, price comparisons, use instructions, and/or the like).

FIG. 5 illustrates a block diagram 500 of a signal flow for visual matching using indexed video content, according to at least one example implementation. As shown in FIG. 5, at block 510, the user may enter a query in a user interface (e.g., UI 110) associated with a search engine (e.g., similar to block 410 of FIG. 4). In some implementations, the query (e.g., referred to as original query in FIG. 5) may be a search for content (e.g., a video) for example, the user may be searching for a “how to” video using the string “how to repair” similar to as shown in FIG. 4 and may generate search results (e.g., links to videos).

At block 520, the user may be prompted to upload an image or a picture (e.g., similar to block 420 of FIG. 4). The image uploaded (e.g., image of the broken lamp) by the user may be referred to as “visual input” from the user. In some implementations, for example, the visual input may be triggered in response to the user entering the search string, in response to some user interaction in a user interface, in response to the user clicking on a button, and/or the like.

At block 522, the visual input (e.g., image uploaded at block 520) may be analyzed for semantic and visual entity information using, for example, using a multi-pass approach. For example, semantic and visual entity information (e.g., manufacturer name, model, etc. of the broken lamp) may be extracted from the image/picture uploaded by the user. In some implementations, the text based on the visual input can be generated in response to object recognition of objects in the visual input. For example, a trained ML model can be used recognize objects in the visual input. The recognized objects can be classified and terms (e.g., text) can correspond to the classification. The trained ML model can be configured to generate classifiers and/or semantic information or text associated with the object. The trained ML model can be configurate a confidence or confidence level based on how likely the object recognition and/or classification is accurate.

At block 524, metadata of the visual input may be generated. In some implementations, for example, the metadata of the visual input may be used to filter search results generated by the search query. For example, the metadata may include at least one term such as “broken” “[brand name]” “lamp” “[serial number] “how-to” “fix” “[color of lamp].”

In some implementations, for example, a video visual metadata library (block 538) may be generated as illustrated in reference to blocks 530-538 and described below in detail. It should be noted that the video visual metadata library (e.g., video corpus with video tagged with metadata, etc.) may be created and stored separately. In other words, the present disclosure describes a mechanism which may use the metadata of the visual input to perform visual matching to indexed video content.

At block 530, video(s) may be uploaded to a video content server. For example, the video (or some other content) can be uploaded by a user using a user interface (e.g., UI 155). At block 532, frames of each of the videos may be analyzed for semantic and visual entity or object information using, for example, a multi-pass approach, similar to the operations performed at block 522 on the visual input (e.g., uploaded image). In an example implementation, analyzing for semantic and visual entity or object information can include the use of a trained machine learned (ML) model. The trained ML model can be used recognize objects in the frame. The recognized objects can be classified and terms (e.g., text) can correspond to the classification. The trained ML model can be configured to generate classifiers and/or semantic information or text associated with the object. The ML model can include a function call to a server including code to execute the model. The ML model can include a function call within code of the UI (e.g., UI 130) which can include code (e.g., as an element of the object recognition 230 block) to execute the model. An example of an ML model for object recognition is described in more detail below.

In addition to, or optionally, at block 534, in some implementations, for example, manual semantic content tagging may be performed. In some implementations, an image associated with the video can be uploaded. The image can be analyzed for semantic and visual entity or object information. In an example implementation, analyzing for semantic and visual entity or object information can include the use of a trained machine learned (ML) model. The trained ML model can be used recognize objects in the frame. The recognized objects can be classified and terms (e.g., text) can correspond to the classification. The trained ML model can be configured to generate classifiers and/or semantic information or text associated with the object. The ML model can include a function call to a server including code to execute the model. The ML model can include a function call within code of the UI (e.g., UI 130) which can include code (e.g., as an element of the object recognition 230 block) to execute the model. An example of an ML model for object recognition is described in more detail below.

In some implementations, for example, a content (e.g., video) creator may tag their own video for metadata that can be used to associate with other users' visual inputs. This may be helpful as the accuracy of this may be higher than automated visual input.

At block 536, video visual metadata for the video may be generated. In some implementations, for example, semantic and visual entities with time stamps may be generated. In some implementations, for example, timestamps may be used for more specific suggestions on relevant video content. In the context of a broken lamp, a suggestion may include that instructions to fix the lamp is from 0:32 to 0:48 in the video (rather than the whole video that may include a full review of other lamps).

At block 538, a video visual metadata library may be generated based on the frame-wise analysis performed on the videos at 532 and video visual metadata generated at 536. It should be noted that the process described in relation to blocks 530, 532, 534, 536, and/or 538 may be performed on thousands/millions of videos to generate the video visual metadata library.

At block 540, the search results of the query at block 510 may be filtered by performing matching against visual metadata. In some implementations, for example, the metadata of the visual input (e.g., generated at 524) may be used to filter the search results based on the combination of block 510 and block 538. For instance, the metadata of the visual input may be used to filter the videos generated by search query.

At 550, the final search results can be presented to the user. In some implementations, the search results based on the query at block 510 may output 1000s of links to videos as output, both relevant and irrelevant videos. However, by filtering the search results by comparing the metadata of the visual input with the metadata in the metadata library (generated and stored offline), the search results may be narrowed down to produce more relevant search results.

The described mechanism provides a useful service to users looking for videos based on a search string and an input image uploaded by the user. Therefore, more relevant search results may be generated based on metadata comparisons as described above.

FIGS. 6 and 7 illustrate block diagrams of methods according to at least one example implementation. The steps described with regard to FIGS. 6 and 7 may be performed due to the execution of software code stored in a memory (e.g., at least one memory 210 and/or search memory 225) associated with an apparatus (e.g., as shown in FIGS. 2A and 2B) and executed by at least one processor (e.g., at least one processor 205) associated with the apparatus. However, alternative embodiments are contemplated such as a system embodied as a special purpose processor. Although the steps described below are described as being executed by a processor, the steps are not necessarily executed by a same processor. In other words, at least one processor may execute the steps described below with regard to FIGS. 6 and 7.

FIG. 6 illustrates a block diagram of a method for building a search query with visual input, according to at least one example implementation. In step S610, a computing device (e.g., device 105) may receive a query. In some implementations, for example, the query may be search string, for example, “how to repair,” as described above in reference to FIG. 4. The search string may be entered as input by a user in a user interface (e.g., UI 110).

In step S620, the computing device may receive a visual input that is associated with the query. In some implementations, the visual input may be triggered in response to the user entering a search string. In an example implementation, once the user enters “how to repair” in a search bar, the user may be prompted to upload an image/picture, for example, of a “broken lamp” (or any other image associated with the query, e.g., a broken coffee maker). In some implementations, the visual input may be triggered in response to the user interacting with the user interface (e.g., pressing a button). The user may use the camera of the computing device to take the image (e.g., of a lamp) and upload it. The image being uploaded may be referred to as the visual input.

In step S630, the computing device may create a composite query based at least on a combination of the query and the visual input. In some implementations, for example, the composite query may be a first composite query (“how to repair a lamp”) which may be created by performing an object identification (e.g., using a trained ML model) on the image (e.g., detecting an object in the image uploaded by the user) and a semantic query addition on the query (“how to repair”) using the identified object (“lamp”). The object identification described above may be referred to as general object identification.

In some implementations, for example, the computing device may further determine if a confidence level (e.g., a first confidence level) in the object identification satisfies a condition, e.g., a first condition, which may be, for example, above or below a first threshold. The confidence level may be associated with how confident the algorithms are in the object identification. In some implementations, for example, the confidence level may be dependent on the quality of visual input received from the user and/or availability of secondary information (e.g., manufacturer of the lamp, model, etc.). If the confidence level is considered to satisfy the condition, the computing device may generate the composite query, e.g., a second composite query, based at least on the semantic addition on the query using at least the identified object (specific object identification) to generate, for example, the second composite query—“how to repair a [branded] lamp.”

In some implementations, for example, the computing device may determine if a confidence level (e.g., a second confidence level) in the object identification satisfies a condition, e.g., a second condition, which may be, for example, above or below a second threshold. As described above, the confidence level may be associated with how confident the algorithms are in the object identification. In some implementations, for example, the confidence level may be based on the quality of visual input received from the user and/or the availability of secondary information (e.g., manufacturer of the lamp, model, etc.). If the confidence level is considered to satisfy the second condition, the computing device may generate the composite query, e.g., a third composite query, based on semantic query addition using at least object and context identification to generate, for example, the third composite query—“how to repair a broken [branded] lamp.”

In some implementations, for example, the first condition and/or second condition may be configured by the user. For example, in some implementations, the first condition may be set to a threshold of 93% and the second condition may be set to a threshold of 95%. In other words, if specific/accurate understanding of the object satisfies the threshold of 95%, the composite query may rely on object and context identification to improve the search results, and so on. In some implementations, the conditions may be configured by the user and/or based on the item the user is searching.

At step S640, the computing device may generate search results based on the composite query (e.g., first, second, or third composite query). In some implementations, for example, the search results may include a plurality of links to content (e.g., videos) that are relevant as output.

Thus, based on the above, the results of a search query may be optimized by augmenting (e.g., appending, augmenting, etc.) the search query with visual input. In other words, the search results based on the original query may be filtered based on visual input from the user.

FIG. 7 illustrates a block diagram of a method of visual matching using indexed video content, according to at least one example implementation. In some implementations, for example, the method may be performed by the computing device of FIG. 2A. In step S710, a computing device (e.g., device 105) may receive a query. In some implementations, the query may be a search string, for example, “how to repair,” as described above in reference to FIG. 5. The search string may be entered as input in a user interface (e.g., UI 110) by a user. The operations at step S710 may be similar to the operations at block 310.

In step S720 a visual input associated with the query is received (the operations may be similar to the operations at block 320). For example, the computing device may receive a visual input that is associated with the query. In some implementations, the visual input may be triggered in response to the user entering a search string. In an example implementation, once the user enters “how to repair” in a search bar, the user may be prompted to upload an image/picture, for example, of a “lamp” or “broken lamp” (or any other image associated with the query, e.g., a broken coffee maker). In some implementations, the visual input may be triggered in response to the user interacting with the user interface (e.g., pressing a button). The user may use the camera of the computing device to take the image of the broken lamp and upload it. The image being uploaded may be referred to as the visual input.

In step S730, the computing device may generate search results based on the query. In some implementations, the computing device may generate search results based on searching performed using the query (e.g., as received at block 510).

In step S740, the computing device may filter the search results using the metadata of the visual input. In some implementations, objects in the visual input can be identified (e.g., using tools of UI 130). The objects can include the primary object in the image (e.g., a coffee maker) and any portions of the primary object (e.g., identifying text, components, and/or the like). Identifying objects can include the use of a trained machine learned (ML) model. The trained ML model can be configured to generate classifiers and/or semantic information or text associated with the object. The metadata can be associated with the identified objects. The search results can be filtered to include content (e.g., videos) whose metadata matches the metadata of the visual input (e.g. identified objects in the image at block 510).

In some implementations, for example, the computing device may filter the search results based on the query at block 510 by matching metadata of the visual input with metadata information in the metadata library. In other words, the results are filtered to output include content (e.g., videos) whose metadata matches the metadata of the visual input (e.g. image at block 510).

At step S750, the computing device generates and presents the final search results. In example implementation, the final search results can be presented in a user interface (e.g., UI 110).

Thus, based on the above, the results of a search query may be optimized by augmenting (e.g., appending, augmenting, etc.) the search query with visual input and comparing the metadata of the image with metadata of the millions of content (e.g., stored video). In other words, the search results based on the original query may be filtered based on visual input from the user to provide more relevant search results.

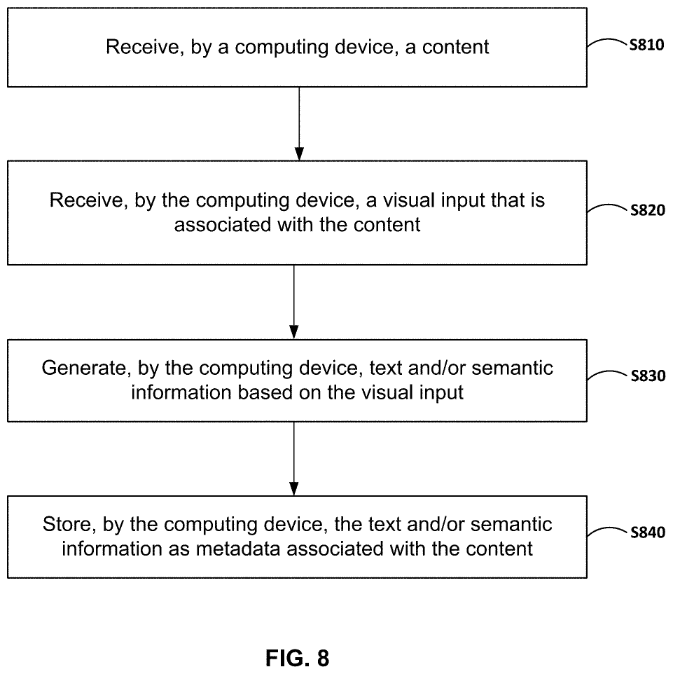

FIG. 8 illustrates a flowchart of a method of visual matching of video content, according to at least one example implementation. As shown in FIG. 8, in step S810 a computing device (e.g., device 150) receives content (e.g., video). For example, a user can generate and upload content (e.g., video) to a searchable data structure associated with, for example a mobile device application, a website, a web application, and/or the like. In some implementations, the user can use a user interface (e.g., UI 155) to upload the content (e.g., video).

In step S820 the computing device receives a visual input that is associated with the content. For example, the user can trigger the user interface to cause the input of an image. The image can be captured (e.g., by a camera of the computing device), selected from a file system, and/or the like. In an example implementation a pop-up user interface (e.g., UI 130) can be used to input the image.

In step S830 the computing device generates text and/or semantic information based on the visual input. In some implementations, objects in the visual input can be identified (e.g., using tools of UI 130). The objects can include the primary object in the image (e.g., a coffee maker) and any portions of the primary object (e.g., identifying text, components, and/or the like). Identifying objects can include the use of a trained machine learned (ML) model. The trained ML model can be configured to generate classifiers and/or semantic information or text associated with the object. The metadata can be associated with the identified objects.

In step S840 the computing device stores the text and/or semantic information as metadata associated with the content. In some implementations, the metadata can be stored in response to user interaction in the user interface (e.g., clicking on a button).

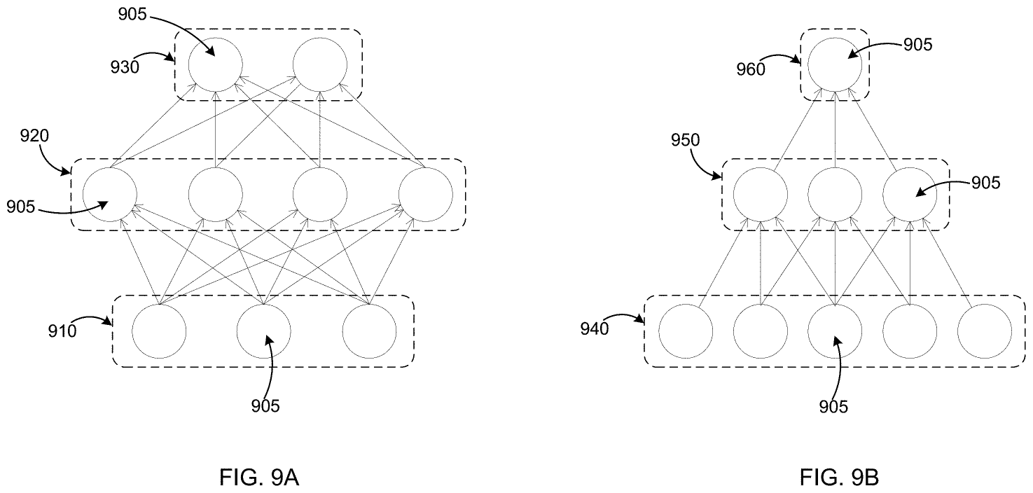

FIG. 9A illustrates layers in a convolutional neural network with no sparsity constraints. FIG. 9B illustrates layers in a convolutional neural network with sparsity constraints. With reference to FIGS. 9A and 9B, various configurations of neural networks for use in at least one example implementation will be described. An example layered neural network is shown in FIG. 9A. The layered neural network includes three layers 910, 920, 930. Each layer 910, 920, 930 can be formed of a plurality of neurons 905. In this implementation, no sparsity constraints have been applied. Therefore, all neurons 905 in each layer 910, 920, 930 are networked to all neurons 905 in any neighboring layers 910, 920, 930.

The example neural network shown in FIG. 9A is not computationally complex due to the small number of neurons 905 and layers. However, the arrangement of the neural network shown in FIG. 9A may not scale up to larger sizes of networks due to the density of connections (e.g., the connections between neurons/layers). In other words, the computational complexity can be too great as the size of the network scales and scales in a non-linear fashion. Therefore, it can be too computationally complex for all neurons 905 in each layer 910, 920, 930 to be networked to all neurons 905 in the one or more neighboring layers 910, 920, 930 if neural networks need to be scaled up to work on inputs with a large number of dimensions.

An initial sparsity condition can be used to lower the computational complexity of the neural network. For example, if a neural network is functioning as an optimization process, the neural network approach can work with high dimensional data by limiting the number of connection between neurons and/or layers. An example of a neural network with sparsity constraints is shown in FIG. 9B. The neural network shown in FIG. 9B is arranged so that each neuron 905 is connected only to a small number of neurons 905 in the neighboring layers 940, 950, 960. This can form a neural network that is not fully connected, and which can scale to function with higher dimensional data. For example, the neural network with sparsity constraints can be used as an optimization process for a model and/or generating a model for use in rating/downrating a reply based on the user posting the reply. The smaller number of connections in comparison with a fully networked neural network allows for the number of connections between neurons to scale in a substantially linear fashion.

In some implementations neural networks that are fully connected or not fully connected but in different specific configurations to that described in relation to FIG. 9B can be used. Further, in some implementations, convolutional neural networks that are not fully connected and have less complexity than fully connected neural networks can be used. Convolutional neural networks can also make use of pooling or max-pooling to reduce the dimensionality (and hence complexity) of the data that flows through the neural network. Other approaches to reduce the computational complexity of convolutional neural networks can be used.

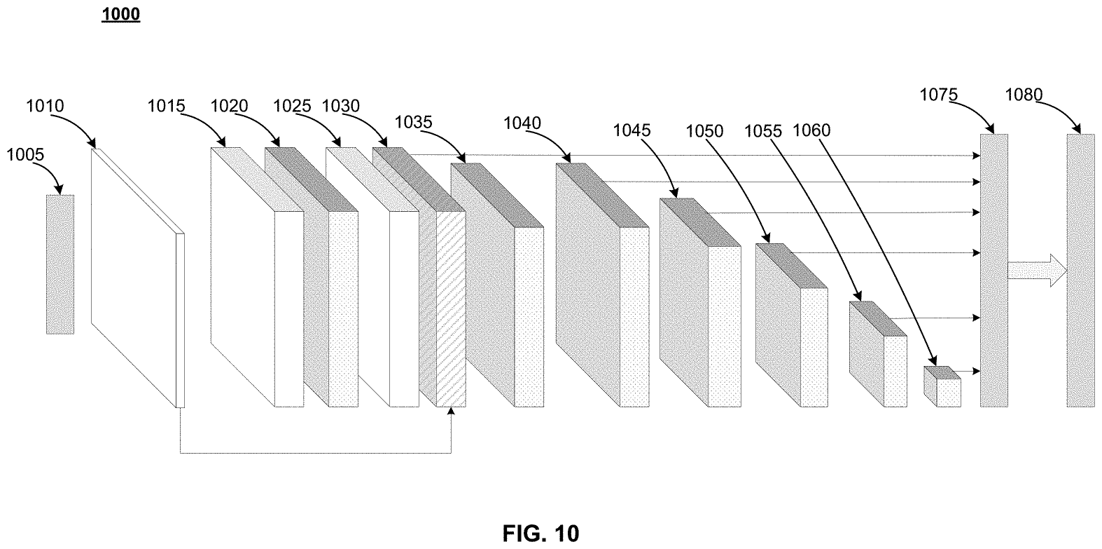

FIG. 10 illustrates a block diagram of a model according to an example embodiment. A model 1000 can convolutional neural network (CNN) including a plurality of convolutional layers 1015, 1020, 1025, 1035 1040 1045, 1050, 1055, 1060 and an add layer 1030. The plurality of convolutional layers 1015, 1020, 1025, 1035, 1040, 1045, 1050, 1055, 1060 can each be one of at least two types of convolution layers. As shown in FIG. 10, the convolutional layers 1015 and the convolution layer 1025 can be a first convolution type. The convolutional layers 1020, 1035, 1040, 1045, 1050, 1055 and 1060 can be a second convolution type. An image (e.g., as uploaded using UI 130) and/or a frame of a video (e.g., as uploaded using UI 155) can be input to the CNN. A normalize layer 1005 can convert the input image into image 1010 which can be used as an input to the CNN. The model 1000 further includes a detection layer 1075 and a suppression layer 1080. The model 1000 can be based on a computer vision model.

The normalize layer 1005 can be configured to normalize the input image. Normalization can include converting the image to M×M pixels. In an example implementation, the normalize layer 1005 can normalize the input image to 300×300 pixels. In addition, the normalization layer 1005 can generate the depth associated with the image 1010. In an example implementation, the image 1010 can have a plurality of channels, depths or feature maps. For example, an RGB image can have three channels, a red (R) channel, a green (G) channel and a blue (B) channel. In other words, for each of the M×M (e.g., 300×300) pixels, there are three (3) channels. A feature map can have a same structure as an image. However, instead of pixels a feature map has a value based on at least one feature (e.g., color, frequency domain, edge detectors, and/or the like).

A convolution layer or convolution can be configured to extract features from an image. Features can be based on color, frequency domain, edge detectors, and/or the like. A convolution can have a filter (sometimes called a kernel) and a stride. For example, a filter can be a 1×1 filter (or 1×1×n for a transformation to n output channels, a 1×1 filter is sometimes called a pointwise convolution) with a stride of 1 which results in an output of a cell generated based on a combination (e.g., addition, subtraction, multiplication, and/or the like) of the features of the cells of each channel at a position of the M×M grid. In other words, a feature map having more than one depth or channels is combined into a feature map having a single depth or channel. A filter can be a 3×3 filter with a stride of 1 which results in an output with fewer cells each channel of the M×M grid or feature map.

The output can have the same depth or number of channels (e.g., a 3×3×n filter, where n=depth or number of channels, sometimes called a depthwise filter) or a reduced depth or number of channels (e.g., a 3×3×k filter, where k<depth or number of channels). Each channel, depth or feature map can have an associated filter. Each associated filter can be configured to emphasize different aspects of a channel. In other words, different features can be extracted from each channel based on the filter (this is sometimes called a depthwise separable filter). Other filters are within the scope of this disclosure.

Another type of convolution can be a combination of two or more convolutions. For example, a convolution can be a depthwise and pointwise separable convolution. This can include, for example, a convolution in two steps. The first step can be a depthwise convolution (e.g., a 3×3 convolution). The second step can be a pointwise convolution (e.g., a 1×1 convolution). The depthwise and pointwise convolution can be a separable convolution in that a different filter (e.g., filters to extract different features) can be used for each channel or ay each depth of a feature map. In an example implementation, the pointwise convolution can transform the feature map to include c channels based on the filter. For example, an 8×8×3 feature map (or image) can be transformed to an 8×8×256 feature map (or image) based on the filter. In some implementation more than one filter can be used to transform the feature map (or image) to an M×M×c feature map (or image).

A convolution can be linear. A linear convolution describes the output, in terms of the input, as being linear time-invariant (LTI). Convolutions can also include a rectified linear unit (ReLU). A ReLU is an activation function that rectifies the LTI output of a convolution and limits the rectified output to a maximum. A ReLU can be used to accelerate convergence (e.g., more efficient computation).

In an example implementation, the first type of convolution can be a 1×1 convolution and the second type of convolution can be a depthwise and pointwise separable convolution. Each of the plurality of convolution layers 1020, 1035, 1040, 1045, 1050, 1055, 1060 can have a plurality of cells and at least one bounding box per cell. Convolution layers 1015, 1020, 1025 and add layer 1030 can be used to transform the image 1010 to a feature map that is equivalent in size to a feature map of the ConV_3 layer of the VGG-16 standard. In other words, convolution layers 1015, 1020, 1025 and add layer 1030 can transform the image 1010 to a 38×38×512 feature map.

Convolution layers 1035, 1040, 1045, 1050, 1055, 1060 can be configured to incrementally transform the feature map to a 1×1×256 feature map. This incremental transformation can cause the generation of bounding boxes (regions of the feature map or grid) of differing sizes which can enable the detection of objects of many sizes. Each cell can have at least one associated bounding box. In an example implementation, the larger the grid (e.g., number of cells) the fewer the number of bounding boxes per cell. For example, the largest grids can use three (3) bounding boxes per cell and the smaller grids can use six (6) bounding boxes per cell.

The detection layer 1075 receives data associated with each bounding box. In an example implementation, one of the boundary boxes can include the primary object (e.g., a coffee maker) and a plurality of additional boundary boxes can include identifying text, components, and/or the like associated with the primary object. The data can be associated with the features in the bounding box. The data can indicate an object in the bounding box (the object can be no object or a portion of an object). An object can be identified by its features. The data, cumulatively, is sometimes called a class or classifier. The class or classifier can be associated with an object. The data (e.g., a bounding box) can also include a confidence score (e.g., a number between zero (0) and one (1)).

After the CNN processes the image, the detection layer 1075 can receive and include a plurality of classifiers indicating a same object. In other words, an object (or a portion of an object) can be within a plurality of overlapping bounding boxes. However, the confidence score for each of the classifiers can be different. For example, a classifier that identifies a portion of an object can have a lower confidence score than a classifier that identifies a complete (or substantially complete) object. The detection layer 1075 can be further configured to discard the bounding boxes without an associated classifier. In other words, the detection layer 1075 can discard bounding boxes without an object in them.

The suppression layer 1080 can be configured to sort the bounding boxes based on the confidence score and can select the bounding box with the highest score as the classifier identifying an object. The suppression layer can repeat sorting and selection process for each bounding box having a same, or substantially similar, classifier. As a result, the suppression layer can include data (e.g., a classifier) identifying each object in the input image.

As described above, convolution layers 1015, 1020, 1025 and add layer 1030 can generate a 38×38×512 feature map. Each of the cells (e.g., each of the 1444 cells) can have at least three (3) bounding boxes. Therefore, at least 4332 bounding boxes can be communicated from the add layer 1030 to the detection layer 1075. Convolution layer 1035 and convolution layer 1040 can be the second type of convolution and be configured to perform a 3×3×1024 convolution and a 1×1×1024 convolution. The result can be a feature map that is 19×19×1024. Each of the cells (e.g., each of the 361 cells) can have at least six (6) bounding boxes. Therefore, at least 2166 bounding boxes can be communicated from the convolution layer 1040 to the detection layer 1075.

Convolution layer 1045 can be the second type of convolution and be configured to perform a 3×3×512 convolution. The result can be a feature map that is 10×10×512. Each of the cells (e.g., each of the 100 cells) can have at least six (6) bounding boxes. Therefore, at least 600 bounding boxes can be communicated from the convolution layer 1045 to the detection layer 1075. Convolution layer 1050 can be the second type of convolution and be configured to perform a 3×3×256 convolution. The result can be a feature map that is 5×5×256. Each of the cells (e.g., each of the 25 cells) can have at least six (6) bounding boxes. Therefore, at least 150 bounding boxes can be communicated from the convolution layer 1050 to the detection layer 1075.

Convolution layer 1055 can be the second type of convolution and be configured to perform a 3×3×256 convolution. The result can be a feature map that is 3×3×256. Each of the cells (e.g., each of the 9 cells) can have at least six (6) bounding boxes. Therefore, at least 54 bounding boxes can be communicated from the convolution layer 1055 to the detection layer 1075. Convolution layer 1060 can be the second type of convolution and be configured to perform a 3×3×128 convolution. The result can be a feature map that is 1×1×128. The cell can have at least six (6) bounding boxes. The six (6) bounding boxes can be communicated from the convolution layer 1060 to the detection layer 1075. Therefore, in an example implementation, the detection layer 1075 can process, at least, 7,298 bounding boxes.

However, additional bounding boxes can be added to the feature map of each convolution layer. For example, a fixed number of bounding boxes (sometimes called anchors) can be added to each feature map based on the number (e.g., M×M) cells. These bounding boxes can encompass more than one cell. The larger the number of cells, the more bounding boxes are added. The likelihood of capturing an object within a bounding box can increase as the number of bounding boxes increases. Therefore, the likelihood of identifying an object in an image can increase by increasing the number of bounding boxes per cell and/or by increasing the number of fixed boxes per feature map. Further, the bounding box can have a position on the feature map. As a result, more than one of the same object (e.g., text, components, and/or the like) can be identified as being in an image.

Once a model (e.g., model 1000) architecture has been designed (and/or in operation), the model should be trained (sometimes referred to as developing the model). The model can be trained using a plurality of images (e.g., products, portions of products, environmental objects (e.g., plants), instruction pamphlets, and/or the like). Training the model can include generating classifiers and semantic information associated with the classifiers.

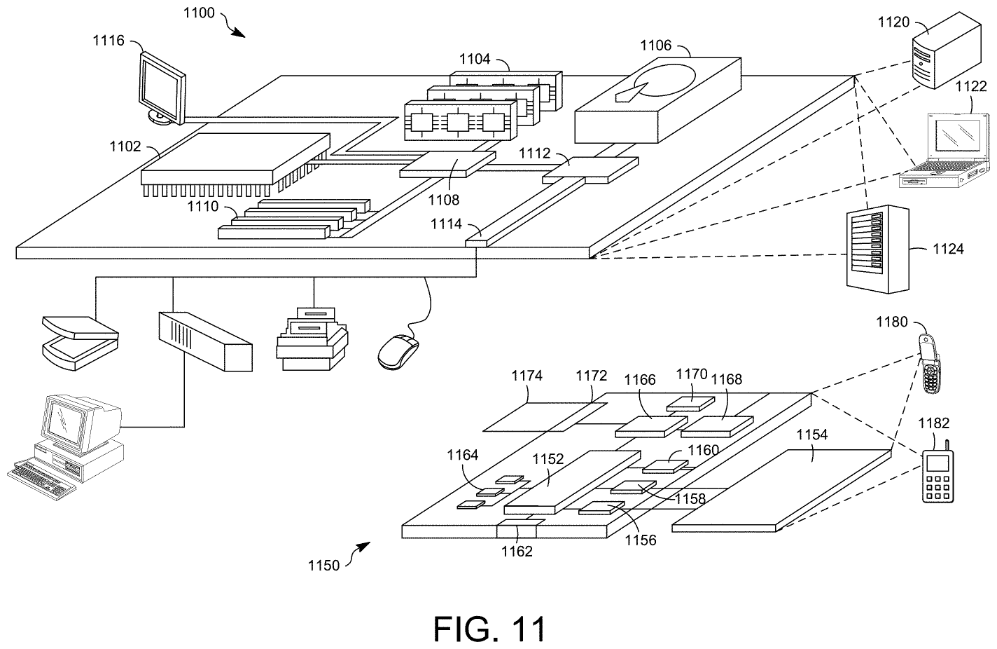

FIG. 11 shows an example of a computer device 1100 and a mobile computer device 1150, which may be used with the techniques described here. Computing device 1100 is intended to represent various forms of digital computers, such as laptops, desktops, workstations, personal digital assistants, servers, blade servers, mainframes, and other appropriate computers. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1104, the storage device 1106, or memory on processor 1102.

The high-speed controller 1108 manages bandwidth-intensive operations for the computing device 1100, while the low speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provide as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, Wi-Fi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1180. It may also be implemented as part of a smart phone 1182, personal digital assistant, or other similar mobile device.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method, comprising:
receiving at a first time, by a computing device, a textual query;
receiving at a second time after the first time, by the computing device, a visual input associated with the textual query;
generating text based the visual input;
generating, by the computing device, a composite query based on a combination of the textual query and the text based on the visual input; and
generating, by the computing device, search results based on the composite query, the search results including a plurality of links to content.

2. The method of claim 1, wherein the composite query is a first composite query, and wherein the creating of the first composite query comprises:
performing an object identification on the visual input; and
performing a semantic query addition on the query using at least an object identified based on the object identification to generate the first composite query, wherein the search results are based on the first composite query.

3. The method of claim 2, wherein the performing of the object identification uses a trained machine learned model.

4. The method of claim 2, wherein
the performing of the object identification uses a trained machine learned model,
the trained machine learned model generates classifiers for objects in the visual input, and
the performing of the semantic query addition includes generating the text based on the visual input based on the classifiers for the objects.

5. The method of claim 2, further comprising:
determining if a first confidence level in the object identification satisfies a first condition; and
performing the semantic query addition on the query using at least the object identified that satisfies the first condition to generate a second composite query, wherein the search results are based on the second composite query.

6. The method of claim 5, further comprising:
determining if a second confidence level in the object identification satisfies a second condition; and
performing the semantic query addition on the query using at least the object identified that satisfies the second condition to generate a third composite query, wherein the search results are based on the third composite query.

7. The method of claim 6, wherein the second confidence level is higher than the first confidence level.

8. The method of claim 6, wherein the first condition and second condition are configured by a user.

9. A method, comprising:
receiving, by a computing device, a textual query;
receiving, by the computing device, a visual input associated with the query;
generating, by the computing device, search results based on the textual query;
generating, by the computing device, textual metadata based on the visual input;
filtering, by the computing device, the search results using the textual metadata; and
generating, by the computing device, filtered search results based on the filtering, the filtered search results providing a plurality of links to content.

10. The method of claim 9, wherein the textual metadata is generated based on analyzing the visual input for semantic and visual entity information.

11. The method of claim 10, wherein the analyzing of the visual input uses a multi-pass approach.

12. The method of claim 10, wherein the analyzing of the visual input uses a trained machine learned model.

13. The method of claim 10, wherein
the analyzing of the visual input uses a trained machine learned model,
the trained machine learned model generates classifiers for objects in the visual input, and
the filtering of the search results includes generating the textual metadata based on the classifiers for the objects.

14. The method of claim 9, wherein the search results of the query are filtered based on matching the textual metadata with textual metadata of videos of a video visual metadata library.

15. The method of claim 10, wherein the analyzing the visual input for semantic and visual entity information includes:
performing an object identification on the visual input;
determining if a first confidence level in the object identification satisfies a first condition, wherein
the filtering of the search results includes using at least the object identified that satisfies the first condition to generate a second composite query, and
the search results are based on the second composite query.

16. The method of claim 15, further comprising determining if a second confidence level in the object identification satisfies a second condition, wherein
the filtering of the search results includes using at least the object identified that satisfies the second condition to generate a third composite query, and
the search results are based on the third composite query.

17. The method of claim 16, wherein the second confidence level is higher than the first confidence level.

18. A method, comprising:
receiving, by a computing device, a content;
receiving, by the computing device, a visual input that is associated with the content;
performing, by the computing device, an object identification on the visual input;
generating, by the computing device, semantic information based on the object identification; and
storing, by the computing device, the content and the semantic information in association with the content.

19. The method of claim 18, wherein the object identification uses a trained machine learned model.

20. The method of claim 18, wherein
the performing of the object identification uses a trained machine learned model,
the trained machine learned model generates classifiers for objects in the visual input, and
the generating of the semantic information includes generating text based on the classifiers for the objects.
